(19) United States
(12) Patent Application Publication
(10) Pub. No.: US 2012/0284015 A1
(43) Pub. Date: Nov. 8, 2012

(54) Method for Increasing the Accuracy of Subject-Specific Statistical Machine Translation (SMT)

(76) Inventor: William Drewes, Houston, TX (US)

(21) Appl. No.: 13/551,752

(22) Filed: Jul. 18, 2012

Related U.S. Application Data
(63) Continuation-in-part of application No. 12/321,436, filed on Jan. 21, 2009.
(60) Provisional application No. 61/024,108, filed on Jan. 28, 2008.
(60) Provisional application No. 61/543,144, filed on Oct. 4, 2011.

(51) Int. Cl. G06F 17/28

(52) U.S. Cl. 704/3

(57) ABSTRACT

A method of improving the accuracy of the translation output of Statistical Machine Translation (SMT), while increasing the effectiveness of an ongoing professional human translation effort by correlating the ongoing professional human translation effort directly with the translation errors made by the system. Once the translation errors have been corrected by professional human translators and are re-input to the system, the SMT's training process may ensure that the same, and possibly similar, translation error(s) may not occur again.

### CROSS-REFERENCE TO RELATED APPLICATIONS

This application is a Continuation-in-part (CIP) of application Ser. No. 12/321,436, filed on Jan. 21, 2009, which in turn claims priority from provisional application Ser. No. 61/024,108, filed on Jan. 28, 2008. This application claims priority from provisional application Ser. No. 61/543,144, filed on Oct. 4, 2011.

### BACKGROUND OF THE INVENTION

1. Field of the Invention

This specification relates generally to statistical machine translations.

2. Description of Prior Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Statistical machine translation (SMT) is a machine translation paradigm where translations are generated on the basis of statistical models whose parameters are derived from the analysis of bilingual text corpora. The statistical approach contrasts with the rule-based approaches to machine translation as well as with example-based machine translation.

The first ideas of statistical machine translation were introduced by Warren Weaver in 1949, including the ideas of applying Claude Shannon's information theory. Statistical machine translation was re-introduced in 1991 by researchers at IBM's Thomas J. Watson Research Center and has contributed to the significant resurgence in interest in machine translation in recent years. Another pioneer in the field of Statistical Machine Translation is Professor Philip Koehn of the University of Edinburgh. Among his many significant accomplishments Professor Koehn formalized the widely used phrase-based models and factored translation models, wrote the textbook on Statistical Machine Translation, and lead the development of the open source Moses translation system, which is used throughout academia and enterprises. As of 2006, SMT is by far the most widely-studied machine translation paradigm.

The benefits of statistical machine translation over traditional paradigms that are most often cited are the following:

Better Use of Resources

1. There is a great deal of natural language in machine-readable format.

2. Generally, SMT systems are not tailored to any specific pair of languages.

3. Rule-based translation systems require the manual development of linguistic rules, which can be costly, and which often do not generalize to other languages. Unlike other MT software, the time that it takes to launch a new language pair can be only weeks or months instead of years.

Unlike the previous generation of machine translation technology, grammatical translation, that relied on collections of linguistic rules to perform an analysis of the source sentence, and then map the syntactic and semantic structure of each sentence into the target language, Statistical machine translation uses statistical techniques from cryptography, utilizing learning algorithms that learn to translate automatically using existing human translations from one language to another (e.g., English to Chinese). Since professional human translators know both languages of the existing human translations, the material translated to the target language in the existing human translation accurately reflects what is actually meant in the source language, including the translation of language specific idiomatic expressions and colloquiums. As a result of adding more existing translations, the training process of statistical machine translation systems is kept up to date, appropriate, and idiomatic, because the translations are derived directly from human translations. Unique to statistical machine translation is statistical machine translation's capability to translate incomplete sentences, as well as utterances.

Statistical Language Pairs

A language pair is the main translation mechanism or translation engine of a Statistical Machine Translation (SMT) system. Creating new language pairs and customizing existing language pairs involves a training process. This training process is a inherent built in component of SMT systems. For statistically based translation software, training material may include previously translated data. The translation system learns statistical relationships between two languages based on the samples that are fed into the system. Because the translation system looks for patterns, the more samples the system finds, the stronger the statistical relationships become.

Once translated data is collected, parallel documents (the original and the translation of the original) are identified and aligned sentence by sentence to create a “parallel corpus.” Parallel corpa is a collection of parallel corpus (e.g., original sentences paired with the translations of the original sentences). The SMT system processes the parallel corpra and extracts statistical probabilities, patterns, and rules, which are called the translation parameters and the language model. The translation parameters are used to find the most accurate translation, while the language model is used to find the most fluent translation. Both of these components (the translation parameters and the language model) are used to create an engine for translating a language pair of the SMT and become part of the delivered translation software for each language pair of the SMT.

In general, the statistical translation process is performed at the sentence level (sentence by sentence) and may include three basic steps. In one step, the source sentence is scanned for known language specific idioms, expressions and colloquialisms, which are then translated into object language words which express the true intended meaning of the language specific idiom, expression, or colloquialisms. In another step which may be performed second, the words of the sentence that can have more than one possible meaning, are given statistical weights or probabilities as to which of the possible meanings of the word, is actually the intended meaning of the word within the particular sentence. In a third step, once the actual meaning of the sentence has been determined, the language model component may use the results of the first two steps as raw data to build a fluent and natural sounding sentence in the target language.

Subject Specific Domains

A subject specific domain is essentially the same as the statistical language pair, described above, with the single exception that, in an embodiment, all source language material to be translated, as per above, is subject specific meaning that, in an embodiment, all recorded material to be translated from the source to the target language, relates precisely to people talking about the same subject. When everybody is talking about the same subject, the meaning of words can then be construed in the context of the subject, and the accuracy of the translation is significantly increased. As a result of the existing translations being subject specific, when choosing among the various possible meanings of the word or expression, which translation is the correct meaning of a word or expression is significantly more apparent and explicit, and therefore the probability of choosing the correct translation is significantly higher.

Inaccuracies in SMT

In order for international business to use and rely on SMT translations on a large scale, it is desirable that SMT translations be consistently accurate. Translation mistakes are simply not acceptable when money is dependent on the translation accuracy of what is stated or written across different human languages.

In a theoretically perfect SMT world, SMT language pairs and subject specific domains would be complete, containing all possible sentence constructs, all possible usages of words, language specific idioms, phrases, expressions, and colloquialisms (which may each include one or more individual words). As a result of the completeness, the theoretically complete SMT should achieve near perfect translation results, but in reality this is not the case.

One basic problem is the availability and cost of professional human translations. Typically, professional human translation of at least 25 million words is required to build a single robust statistical language pair. In addition, subject specific domains of a medium to large scope typically require professional human translations of at least 10 million words, which in an embodiment, all relate directly to the specific subject of the domain.

Among major western countries, such as the U.S.A., France and Germany enough bilingual human translation archives exist for the initial creation of statistical language pairs. In order to ensure that the statistical language pairs stay up-to-date with, and relevant to the natural changes to languages that evolve over time, ongoing human translation of a statistically valid portion of all original language material submitted for translation by users of the system, must also be translated by professional human translators, and input to the SMT system training process in order to refresh and keep the language pair up-to-date.

A problem with the above detailed process of updating and refreshing statistical language pairs is that there is no direct correlation between the translation errors made by the SMT system, and the ongoing professional human translations of original language material submitted for translation by users of the system.

As a result, translation errors continue to be made by the system due to deficiencies in a statistical language pair's lack of knowledge relating to certain sentence constructs as well as the particular usages of certain words, language specific idioms, phrases, expressions and colloquialisms (e.g., all consisting of one or more individual words). The exact same problem also pertains to subject specific domains, described above.

It would therefore be beneficial for a method to be devised that may both ensure a significantly improved accuracy rate of SMT translations, while at the same time increasing the effectiveness of the required ongoing human translation effort and related cost by specifically correlating the professional human translation effort directly to the translation errors made by the system. Once the translation errors have been corrected by professional human translators and the corrected parallel corpora input into the system, the SMT's training process to ensure that the same, and possibly similar, translation error(s) may thereafter not occur again. Some related references are as follows,

US Patent 20110022381 entitled, “Active Learning Systems and Methods for Rapid Porting of Machine Translation Systems to New language pairs or New Domains,” Jan. 27, 2011 (IBM);

U.S. Pat. No. 7,209,875 entitled “System and method for machine learning a confidence metric for machine translation,” Apr. 24, 2007 (Microsoft);

U.S. Pat. No. 7,149,687 entitled “Method of active learning for automatic speech recognition,” Dec. 12, 2006 (AT&T Corp., New York, N.Y.);

Error Detection for Statistical Machine Translation Using Linguistic Features; Deyi Xiong, Min Zhang, Haizhou Li, Human Language Technologies: The 2009 Annual Conference of the North American Chapter of the ACL, pages 415-423;

Yasuhiro Akibay, Eiichiro Sumitay, Hiromi Nakaiway, Seiichi Yamamotoy, and Hiroshi G. Okunoz, 2004, “Using a Mixture of N-best Lists from Multiple MT Systems in Rank-sum-based Confidence Measure for MT Outputs;” In Proceedings of COLING;

Adam L. Berger, Stephen A. Della Pietra and Vincent J. Della Pietra. 1996, “A Maximum Entropy Approach to Natural Language Processing,” Computational Linguistics, 22(1): 39-71;

John Blatz, Erin Fitzgerald, George Foster, Simona Gandrabur, Cyril Goutte, Alex Kulesza, Alberto Sanchis, Nicola Ueffing. 2003; Confidence estimation for machine translation, final report, jhu/clsp summer workshop;

Debra Elliott, 2006, “Corpus-based Machine Translation Evaluation via Automated Error Detection in Output Texts,” PhD. Thesis, University of Leeds;

Simona Gandrabur and George Foster, 2003; “Confidence Estimation for Translation Prediction;” In Proceedings of HLT-NAACL;

S. Jayaraman and A. Lavie, 2005, “Multi-engine Machine Translation Guided by Explicit Word Matching,” In Proceedings of EAMT;

Philipp Koehn, Franz Joseph Och, and Daniel Marcu, 2003. Statistical Phrase-based Translation; In Proceedings of HLT-NAACL;

Philipp Koehn, Hieu Hoang, Alexandra Birch, Chris Callison-Burch, Marcello Federico, Nicola Bertoldi, Brooke Cowan, Wade Shen, Christine Moran, Richard Zens, Chris Dyer, Ondrej Bojar, Alexandra Constrantin, and Evan Herbst, 2007, “Moses: Open source toolkit for statistical machine translation,” In Proceedings of ACL, Demonstration Session;

V. I. Levenshtein, 1966, “Binary Codes Capable of Correcting Deletions, Insertions and Reversals,” Soviet Physics Doklady, February;

Franz Josef Och, 2003, “Minimum Error Rate Training in Statistical Machine Translation,” In Proceedings of ACL 2003;

Kishore Papineni, Salim Roukos, Todd Ward and WeiJing Zhu. 2002. BLEU: a Method for Automatically Evaluation of Machine Translation. In Proceedings of ACL 2002;

Sylvain Raybaud, Caroline Lavecchia, David Langlois, Kamel Sma″ili, 2009, “Word- and Sentence-level Confidence Measures for Machine Translation,” In Proceedings of EAMT 2009;

Alberto Sanchis, Alfons Juan and Enrique Vidal, 2007, “Estimation of Confidence Measures for Machine Translation,” In Proceedings of Machine Translation Summit XI;

Daniel Sleator and Davy Temperley, 1993, “Parsing English with a Link Grammar,” In Proceedings of Third International Workshop on Parsing Technologies;

Yongmei Shi and Lina Zhou, 2005, “Error Detection Using Linguistic Features,” In Proceedings of HLT/EMNLP 2005;

Andreas Stolcke, 2002, “SRILM—an Extensible Language Modeling Toolkit,” In Proceedings of International Conference on Spoken Language Processing, volume 2, pages 901-904;

Nicola Ueffing, Klaus Macherey, and Hermann Ney. 2003. Confidence

Measures for Statistical Machine Translation. In Proceedings. of MT Summit IX;

Nicola Ueffing and Hermann Ney, 2007, “Word Level Confidence Estimation for Machine Translation,” Computational Linguistics, 33(1):9-40;

Richard Zens and Hermann Ney. 2006. N-gram Posterior Probabilities for Statistical Machine Translation,” In HLT/NAACL: Proceedings of the Workshop on Statistical Machine Translation.

### SUMMARY OF THE INVENTION

In the remainder of this specification, unless expressly indicted otherwise, all references to the modified statistical machine translation (SMT) of this specification and not to prior art SMTs. The statistical nature of statistical machine translation (SMT) and the way that statistical machine translation (SMT) works can be improved in a manner that that may significantly improve the accuracy of statistical machine translation (SMT) translation, while at the same time increase the effectiveness of the required ongoing human translation effort and related cost thereof by specifically correlating the professional human translation effort directly to the translation errors made by the system.

First, in an embodiment, the basic unit of translation of SMT is the sentence, in that SMT translates a document one sentence at a time, sentence by sentence.

Since each word in any sentence may have one or more meanings, SMT calculates the numerical probability that the translation of a word is correct for the different possible meanings for each individual word in the sentence (FIG. 3). SMT systems currently choose the meaning of a specific word within a sentence with the highest probability that the translation of a word is correct, as the correct meaning of the word, and then strings together the chosen meanings of each word as the translation of the sentence.

For example, a sentence may contain a particular word with four different possible meanings with respective corresponding translation correctness numerical probabilities of 26%, 25%, 25% and 24%.

The above example clearly demonstrates a basic problem. The meaning of the word corresponding to the probability that the translation of a word is correct of 26%, may be used by a prior art SMT as the correct meaning of the particular word in the translation of the sentence, despite of the fact there is clearly only a one in four chance that this chosen meaning is actually correct.

A methodology is disclosed that changes the way that SMT determines if a word has been translated correctly or not. The methodology, together with the disclosed error correction systems (below), may significantly improve the accuracy of SMT translation.

System methodologies to translate three types of data; bulk text material data, E-Mail data as well as interactive conversational voice data sentences are presented and explained.

Three translation error correction systems to effect the correction of incorrectly translated bulk text material sentences, as well as incorrectly translated e-mail sentences, as well as incorrectly translated interactive conversational data sentences, are presented and explained.

Professional human translation may then utilize the respective error correction system to correctly translate the source language sentence into a corresponding target language sentence, thereby creating correctly translated parallel corpus source and target language sentences. The correctly translated parallel corpus source and target language sentences may then be input to the training facility of the SMT system for the respective subject specific domain, thus utilizing the SMT training facility” to expand the knowledge base of the SMT system's respective Subject Specific domain, thereby ensuring that the incorrectly translated sentence may be thereafter translated correctly.

Any of the above embodiments may be used alone or together with one another in any combination. Inventions encompassed within this specification may also include embodiments that are only partially mentioned or alluded to or are not mentioned or alluded to at all in this brief summary or in the abstract.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is a diagram illustrating an embodiment of the flow for correcting errors in the translation of sentences in bulk text material and e-mails.

FIG. 2 is a diagram illustrating an embodiment of the flow for correcting errors in the translation of the interactive conversational sentences.

FIG. 3 is a diagram illustrating an example of an internally generated table of percentages generated an embodiment of the statistical machine translation (SMT) system in which each percentage represents the probability that a given translation of a word is correct.

FIG. 4 is a diagram illustrating an embodiment of the flow of voice-to-voice translation process.

FIG. 5 shows a block diagram of a system, which may be used as a SMT.

FIG. 6 shows a screen shot of an embodiment of a webpage for setting a threshold value for a subject-specific domain.

FIG. 7 shows a a screen shot of an embodiment of a webpage for starting a translation of a bulk batch text material.

FIG. 8 a screen shot of an embodiment of a webpage for the process of translating an E-Mail.

FIG. 9 a screen shot of an embodiment of a webpage for the process of translating of a voice-to-voice interactive conversation.

FIG. 10 a screen shot of an embodiment of a webpage for the process of correcting errors in Bulk Text Material and E-Mail.

FIG. 11 a screen shot of an embodiment of a webpage for the process of correcting errors in an interactive voice-to-voice translation.

### DETAILED DESCRIPTION OF THE INVENTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

In an embodiment there are three basic types of material that can be submitted for translation by SMT, as follows: (1)—Bulk text material consisting of prewritten material including of multiple sentences, often many pages consisting of multiple sentences, and (2)—Interactive conversational data, such as voice-to-voice translation of conversation participant's dialogue in real-time among two or more participants, and (3)—Translation of e-mails during composition.

Modifications and Additions to Voice-To-Voice Translation Systems Which Utilize Statistical Machine Translation (SMT):

Utilizing the methodology of this specification, the voice-to-voice conversation to be translated must relate to a single specific business department functional area relating specifically to a single ongoing daily operation of the organization's business. In other words, the voice conversation to be translated must be highly subject-specific.

In an embodiment, the user may select a subject menu icon, and a drop-down menu may appear displaying the available subject specific business operational functions. The user may then select the specific business operational function about which the conversation is to be conducted, as well the source language of the participant initiating the voice-to-voice conversation and the target language to, and from, which the conversation is to be translated. The selection of a specific business operational function selected in the above mentioned menu, as well as the selection of the source and target languages may determine the specific subject-specific domain to be used for the SMT translation of the voice-to-voice conversation.

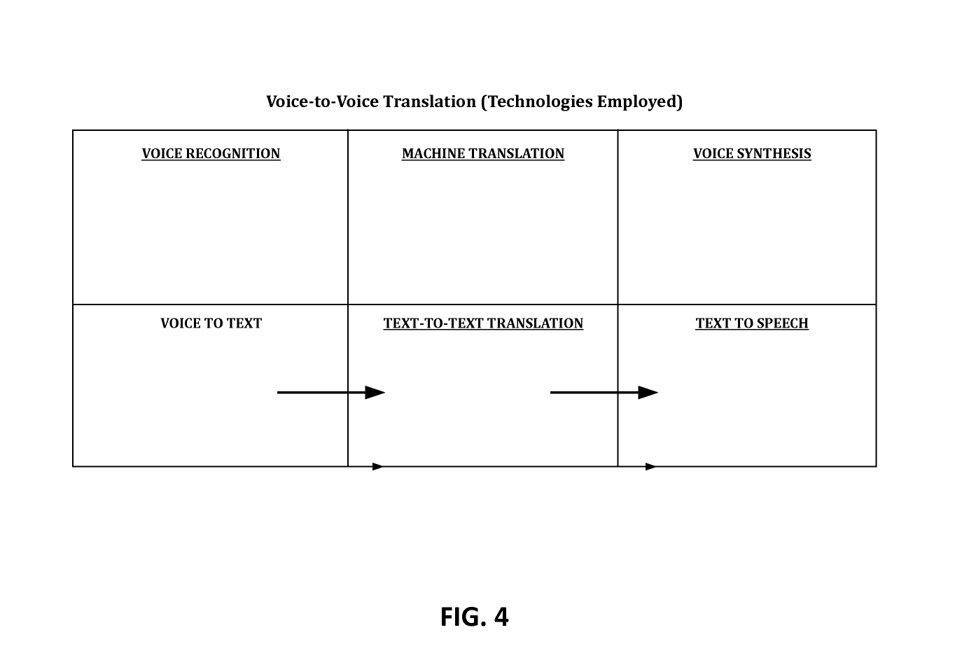

In an embodiment, the voice-to-voice translation systems of the SMT performs the translation in three steps (utilizing three technologies) in performing a voice to voice translation, as follows: (1) first a voice recognition to text operation is performed to convert a received voice message into text, (2)—text to text translation is performed in which the text resulting text from the voice recognition to text operation is translated from one language to another, and (3) then a-voice synthesis is performed on the translated text that results from the text to text translation (FIG. 4).

Determining the End of an Audio Sentence:

Since SMT translation translates text on a sentence-by-sentence basis, in an embodiment, the end of each sentence is determined. Although, in most languages, in written text the end of a sentence is indicated by placing a period at the end of the sentence, in spoken dialogue the speakers do not necessarily clearly indicate the end of a sentence. In an embodiment, indicating the location of the end of each sentence is made incumbent on each participant of the conversation. Indicating the end of a sentence may be accomplished by requesting each participant to press a specific button (e.g., the pound button, asterisk, or other button) on a keypad or keyboard of the telephone or computer of the user, in order to indicate to the voice-to-voice translation system that the current sentence is complete.

In an embodiment, the end of a sentence is determined by employing text based algorithms which automatically determines the end of a sentence with a high probability of success and thereby may automatically indicate to the voice-to-voice translation system that the conversation participant has completed vocalizing a single complete sentence. This embodiment has the advantage of enabling a conversation participant to continue speaking without the interruption of having to perform an action in order to indicate, as detailed above, the end of each sentence spoken.

Once a sentence has been identified, the below processes may be initiated.

Creation of the Sentence Information File (SIF File) for Voice-to-Voice Translation Systems:

In an embodiment, a file, which may be referred to as a sentence information file (SIF), is created. In an embodiment, the SIF contains a unique file identification key that identifies each specific conversation processed by the system.

An audio recording of each individual sentence spoken by each conversation participant is made in real-time, and stored in a record, which may be stored in the SIF. In an embodiment, the SIF may be a table or equivalent object or a database (e.g. a relational database), and the record is a database record. Each record of the SIF relates to a single sentence that was spoken during a specific conversation by a single participant of the conversation, which is being managed by the voice-to-voice translation system. In an embodiment, the SIF record contains information identifying the specific conversation participant who spoke the sentence, as well as a unique indicator identifying the specific conversation.

In the event that a Voice Recognition (VR) error occurs during the voice to text transcription of a specific sentence, the VR error, is recorded and stored in the SIF record corresponding to the sentence and the VR error is also recorded and stored in the Translation Error File record corresponding to the sentence, as detailed below. In an embodiment a storage and retrieval key is created for uniquely identifying the SIF record, which is used for SIF record storage and subsequent retrieval. For example, the retrieval key may be database key, which maybe a row in a database table in which the unique indicator is stored. In an embodiment, the storage and retrieval key for the SIF record is stored in the associated translation error record, which is stored in a translation error file, described below.

In an embodiment, the SIF record contains the below detailed data extracted via the voice-to-voice translation system subsequent to the translation of each sentence, as follows:

(1)—An audio recording of the single sentence as spoken by conversation participant.

(2)—The unique ID Identification of participant whom spoke the single sentence.

(3)—The unique ID for the specific telephone conversation processed by the voice-to-voice translation system.

(4)—An indicator of whether a voice recognition (VR) error occurred. ext.

The Error-Correction Loop: A Method to Ensure the Accurate Translation of the Speakers' True Meaning & Intent:

Additions and modifications may be made to a voice-to-voice translation system, which utilizes SMT Translation for the implementation of the below detailed error correction loop, as follows:

In an embodiment, the complete sentence text is conveyed from the voice recognition system to the SMT module, and the SMT module determines if the sentence has been either translated correctly or translated incorrectly, as detailed below. Communications to and from the SMT module may be facilitated through an application program interface (API) for the SMT. The API may include functions, method calls, object calls, and/or other routine calls, which when included in the voice recognition (VR) system invoke the corresponding routine of the SMT. Calls, method calls, object calls, and/or other routine calls, which when included in the voice recognition (VR) system invoke the corresponding routine of the SMT.

In the case that the SMT module determines that a sentence has been translated correctly, the conversation participant who spoke the sentence may optionally hear a signal, such as “beep-beep,” generated by the voice-to-voice translation system (beep or other signal may be generated by a DSP under the control of the voice-to-voice translation system). In other words, the signal may indicate to the participant of the conversation that the previous sentence spoken by the participant was translated correctly, and that the conversation participant may continue to vocalize his or her next sentence.

In the case that the SMT module determines that that the sentence has been translated incorrectly, and/or a Voice Recognition (VR) error has been detected in a the sentence by the VR component, the voice-to-voice translation system (1)—informs the participant that spoke the sentence, that the sentence was not understood by the system (the voice synthesis synthesizes a statement or a recording is played stating that the sentence was not understood), and (2)—optionally, the audio recording of the sentence is is played to the participant that spoke the sentence (e.g., the SIF record where a recording of the sentence was stored is retrieved and played), and (3)—the participant is requested (via a playing recording, playing voice synthesizer, and/or displaying a message, on a display screen) to rephrase and/or vocalize the sentence optionally in a simpler and/or clearer manner.

The above process is repeated until the SMT module determines that the rephrased sentence has been translated correctly. By requesting the user to restate and/or rephrase the sentence that was not translated correctly, the above process may assure (or at least significantly improve the likelihood) that when a sentence is determined to have been translated correctly, even though it may not be the speakers original sentence, what is finally translated and heard by the other conversation participant(s) (in each conversation participants' own respective language) actually conveys the true meaning and intent of the speaker.

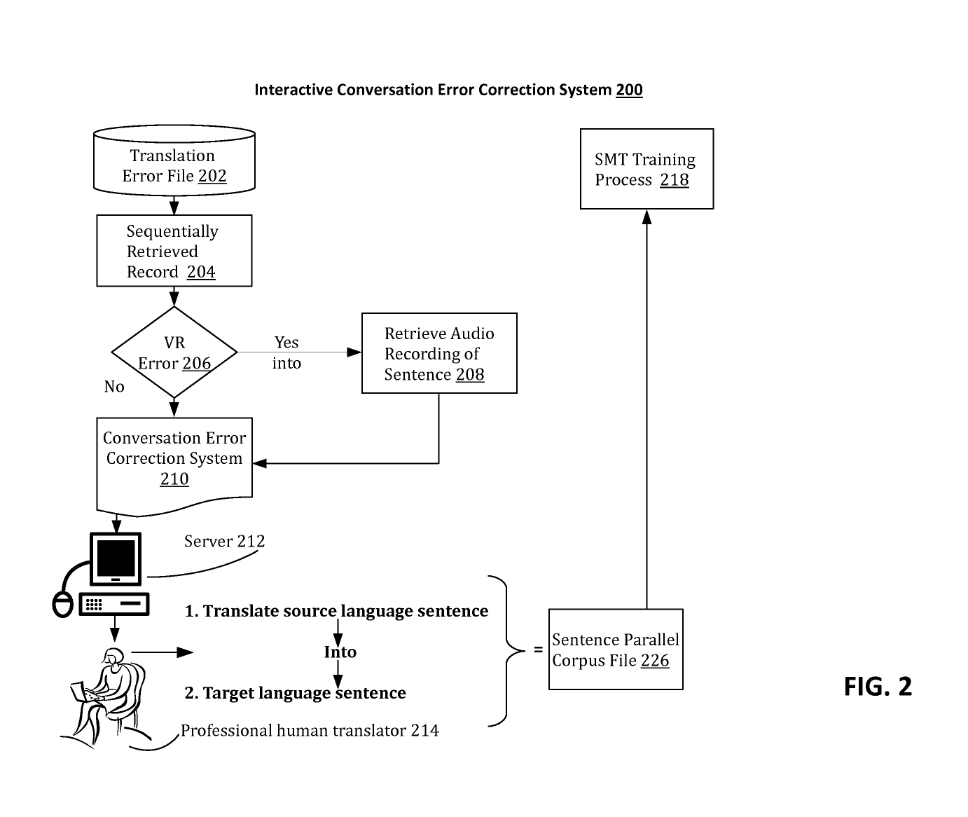

In an embodiment, all sentences that were translated incorrectly by the SMT system are automatically processed and corrected within the interactive conversation error correction system (FIG. 2), as detailed below, and subsequent corrections may be input to the SMT training system. The SMT training system may be a component of SMT translation systems, as detailed below. By correcting the translation errors and inputting the corrections to the SMT training system, the SMT system may thereafter be taught to understand these previously incorrectly translated sentences, and (e.g., by the next day) the same or similar translation error(s) may not happen again. By correcting the translation errors and inputting the corrections to the SMT training system, the accuracy of the Interactive Voice-to-Voice translation system may thereby continually increase on an on-going basis.

Modifications and Additions to Bulk Text Material Translation Systems which Utilize Statistical Machine Translation (SMT):

The bulk text material translation function may be initiated as a computer application. First, the user locates and specifies the bulk translation material file to be translated. For each Bulk Text Material translation a Translation File ID may optionally be either automatically generated by the system or manually specified by the user.

In an embodiment, it may be desirable for the bulk text material to relate to a single specific business department functional area relating specifically to a single ongoing daily operation of the organization's business. In other words, in this embodiment, it may be desirable for the translated Bulk Text Material to be highly subject-specific.

The user may select a subject menu icon and a drop-down menu may appear displaying the available subject specific business operational functions. The user may then select the specific business operational function about which the bulk text material is written, as well the source language in which the bulk text material is written and the target language to which the bulk text material is to be translated. The selection of a specific business operational function selected in the above mentioned menu, as well as the selection of the source and target languages may relate directly to, and determine, the specific subject-specific domain to be used for the SMT translation of the bulk text translation material.

Since the SMT translates text on a sentence-by-sentence basis, one sentence at a time, it is important to know where a sentence ends. In most languages, written text has a period at the end of a sentence. It may therefore be made incumbent upon the user to ensure that each sentence in bulk text material to be translated ends with a period. Alternately, text based algorithms may be employed which determine the end of a sentence with a high probability of success, and once identified, a period may be automatically placed at the end of sentences.

To initiate the translation process, the user may then select a translate icon or to perform another such predefined application function to initiate the translation of the bulk text material.

After the translation process is complete, the translation program may indicate that translation processing has completed, and may also indicate if translation errors were detected in the bulk text material translation source document sentences.

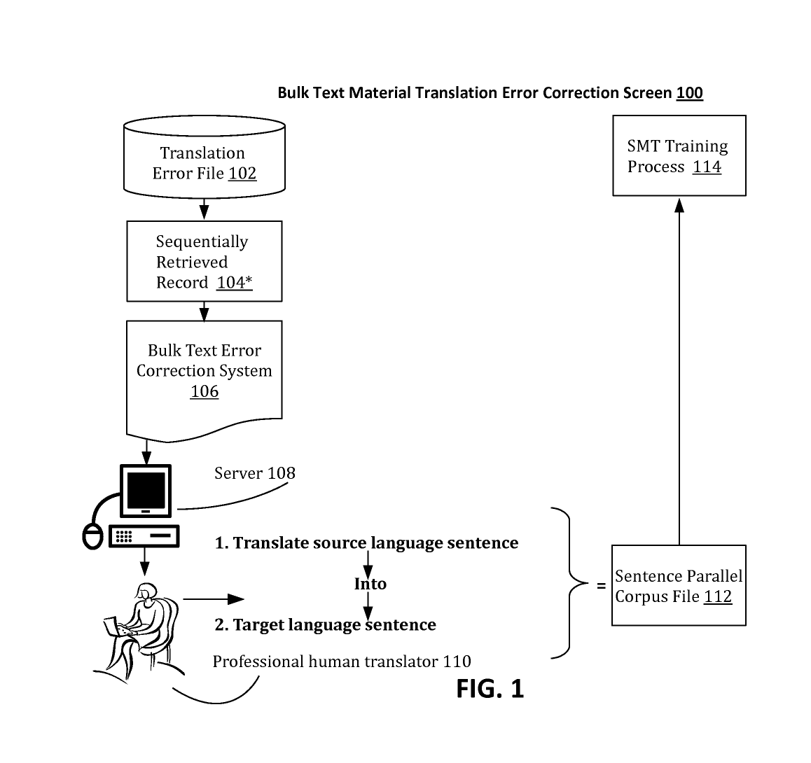

In the case that translation errors were encountered in the bulk text material source document, the user may be able to initiate a computer function to generate the bulk material translation text report, as detailed herein below. In and embodiment, all sentences that were translated incorrectly by the SMT system are automatically processed and corrected within the bulk material & e-mail error correction system (FIG. 1), as detailed below, and subsequent corrections may be input to the SMT training system which SMT training system is a component of SMT Translation systems, as detailed below. In this manner, the SMT system may thereafter be taught to understand these previously incorrectly translated sentences, and (e.g., by the next day) the same or similar translation error(s) may not happen again. In this manner, the accuracy of subject-specific Bulk Material text translation system may thereby continually increase on an on-going basis.

Modifications and Additions to E-Mail Translation Systems which Utilize Statistical Machine Translation (SMT):

The user may select a translation program add-on icon which may provide all of the below detailed functionality. The add-on icon may be made down loadable to a variety of widely used e-mail programs.

Utilizing the methodology of this specification, the e-mail to be written must of this specification relate to a single specific business department functional area relating specifically to a single ongoing daily operation of the organization's business. In other words, the e-mail that is written to be translated must be highly subject-specific.

First, the user may select a subject menu icon and a drop-down menu may appear displaying the available subject specific business operational functions. The user may then select the specific business operational function about which the e-mail is to be written, as well the source language in which the e-mail may be written and the target language to which the e-mail is to be translated. The selection of a specific business operational function selected in the above mentioned menu, as well as the selection of the source and target languages may relate directly and determine the specific subject-specific domain to be used for the SMT translation of the e-mail.

Since SMT translation translates text on a sentence-by-sentence basis, one sentence at a time, it is important to know where a sentence ends. In most languages, written text has a period at the end of a sentence. It therefore may be made incumbent upon the user to ensure that each sentence written in the e-mail ends with a period. The user may then write the e-mail in free form text with a period at the end of each sentence. Alternately, text based algorithms may be employed which determine the end of a sentence with a high probability of success, and once identified, a period may be automatically placed at the end of sentences.

When the user has completed composing the e-mail, he/she may then select a translate icon, and the translated e-mail may appear in either the same or separate window, as may be specified by the user.

In the case that the SMT error correction system detected translation error(s), the translation error may be indicated, and the e-mail written by the user may appear either in the same or a separate window, as may be specified by the user. In the case that translation errors have occurred, the specific sentences which have been translated incorrectly may be highlighted utilizing highlighting technique to bring to the attention of the composer of the e-mail both the incorrectly translated sentence(s), as well as the specific word(s) within each incorrectly translated sentence which SMT determined to have been translated incorrectly. For example, highlighting incorrectly translated sentences in one color (e.g., yellow), while the specific word(s) within the sentence that have been translated incorrectly may be highlighted in a different color (e.g., red).

The above detailed method of indicating sentence errors may provide the user with enough information to rewrite the translation error sentences in simpler or different words, while being careful not to repeat the specific words or phrases that were not understood by the translation system (e.g., those marked in red). When finished correcting the error sentences in the e-mail, the user may then select a translate icon, and the re-translated e-mail may appear in either the same or separate window, as may be specified by the user.

The above process may be repeated, via a programming loop, until the translated e-mail indicates that no translation sentence errors were detected, and the user can then proceed to send the e-mail to the intended recipient(s). In an embodiment, the user does not have the capability to send the e-mail until the point that the system determines that all translation error sentences have been corrected. By way of example, one method to prevent the user from sending the e-mail, as stated above, is to disable the e-mail send function (e.g. screen send button) until the point that the system determines that all translation error sentences have been corrected.

The above process assures that when a sentence is determined to have been translated correctly, even though it may not be the sentence as initially written, what is finally translated and read by the e-mail recipients, may actually convey the true “meaning and intent” of the composer of the e-mail.

In an embodiment, all sentences that were translated incorrectly by the SMT system are automatically processed and corrected within the bulk text material & e-mail error correction system (FIG. 1), as detailed below, and subsequent corrections may be input to the SMT training system. The SMT training system is a component of SMT translation systems, as detailed below. By sending sentences that were translated incorrectly to the bulk text material and e-mail error correction system and sending the corrections to the SMT training system, the SMT system may thereafter be taught to understand these previously incorrectly translated sentences, and (e.g., by the next day) the same or similar translation error(s) may not happen again. In this manner, the accuracy of the E-Mail translation system may thereby continually increase on an on-going basis.

Modifications and Additions to Statistical Machine Translation (SMT) Systems which Utilize Subject-Specific Domain(s) in the Translation Process

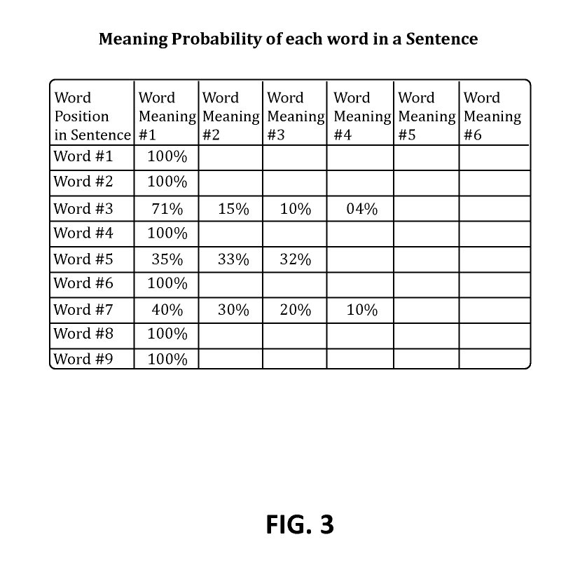

Since each word in any sentence may have one or more meanings, SMT calculates the numerical probability that the translation of a word is correct for the different possible meanings for each individual word in the sentence (FIG. 3). SMT systems currently choose the meaning of a specific word within a sentence with the highest probability that the translation of a word is correct, as the correct meaning of the word and uses the meaning in the translation of the sentence.

For example, a sentence may contain a particular word with four different possible meanings with respective corresponding translation correctness numerical probabilities of 26%, 25%, 25% and 24%.

The above example clearly demonstrates a basic problem. The meaning of the word corresponding to the probability that the translation of a word is correct of 26%, may be used by SMT as the correct meaning of the particular word in the translation of the sentence, in spite of the fact there is clearly only a one in four chance that this chosen meaning is actually correct.

Method to Determine if a Sentence has been Translated Correctly, or Not

The solution disclosed in the present specification is to change the way that SMT determines if a word has been translated correctly or not.

During SMT program run time, after SMT has translated a single sentence, the data relating to the probability that the translation of a word is correct, generated by SMT, relating to the different possible meanings of each word in the sentence is located in computer memory utilized by the SMT program (FIG. 3). The SMT program may be modified so that this data can be accessed and optionally extracted by utilizing an API (Application Program Interface), or any other method known to those skilled in the art.

During SMT program run time, after SMT has translated each single sentence, the data relating to the probability that the translation of a word is correct, generated by SMT, relating to the different possible meanings of each word in the sentence is accessed or extracted computer from memory utilized by the SMT program (FIG. 3), as detailed above.

The methodology, detailed below, for the determination of if a sentence has been translated correctly by SMT, consists of first, enabling the user to define a threshold percentage value. The user may modify the threshold percentage value prior to or after each run time of the SMT Translation program.

During SMT run time, after SMT has translated a single sentence, the data relating to the highest probability that the translation of a word is correct relating to each of the words in the sentence (FIG. 3) are compared to the user defined threshold percentage value. In an embodiment, the sentence is determined to have been translated correctly only in the case that the highest probability that the translation of a word is correct value relating to each and every word in the sentence is either equal to or higher than the user defined threshold percentage value. Otherwise the sentence is determined to have been translated incorrectly. In the case that a sentence is determined to have been translated correctly, the meaning of each word in the sentence corresponding to the highest probability that the translation of a word is correct of the word, is used as the correct meaning of the word to be used in the translation of the sentence.

This approach, as detailed below, has the significant benefit of enabling the controlled ongoing systematic improvement in the accuracy, quality and relevance of the parallel corpora which comprise Subject-Specific domains.

Determining the Initial Threshold Percentage Value to be Used for a Specific SMT Subject-Specific Domain

There is a direct correlation between the accuracy of SMT translation and the correctness and relevance of the Parallel Corpora comprising the subject-Specific domain.

Given the quality of an existing subject-specific domain, the user may choose a threshold value which may render a reasonable amount of errors, given the human translator resources available to the user, without overloading the human translator resources available for the Error Correction System, described below.

One problem is to determine the initial threshold value for a specific subject-specific domain. If the threshold value is set too high, almost every sentence translated may be determined to be translated incorrectly. Conversely, if the threshold value is set too low, almost no sentences may be determined to be translated incorrectly.

Determining the optimal initial threshold percentage value” for a specific subject-specific domain is a two step process, as follows:

First, a file is created that contains a large amount of sentence data relating to a specific job function that is directly and exclusively relevant to a specific subject-specific domain. The file that is created will be referred to in this specification as the subject-specific domain accuracy improvement file” (SSDAI file). The SSDAI may contain the same sort of information as a subject specific domain. The difference between the parallel sets of sentences in the SSDAI and the parallel sets of sentences of the subject specific domain is that sentences in the subject specific domain have been processed by the SMT training system, and therefore may be properly translated with 100% probability, whereas the sentences of the SSDAI have not yet been processed by the SMT training system.

Secondly, utilizing a specific SSDAI file and the subject-specific domain for which this file was created, a computer program, as detailed below, which may determine the initial threshold value to be used for this specific subject-specific domain.

Creation of the Subject-Specific Domain Accuracy Improvement File (SSDAI File)

The source of the subject-specific data for the creation of the subject-specific domain accuracy improvement file SSDAI file may vary corresponding to the three translation methods disclosed in the present invention: (1)—voice-to-voice translation, (2)—e-mail translation, and (3)—bulk text material translation. The following methods of data collection are meant by way of example, and are not intended to be limiting in any way:

(1)—Voice-to-Voice Translation:

Audio recordings of conversations relating a specific organizational function, the subject of conversations directly corresponding to the subject of a specific Subject-Specific Domain, are processed by voice recognition technology which may transform the audio to text. Human involvement may be required to review the text and ensure that a period is placed at the end of each sentence. Alternately, text based algorithms may be employed that automatically determine the end of a sentence with a high probability of success. When the algorithm has determined that the end of a sentence has been encountered, a period may be inserted at the end of sentence.

(2)—E-Mail Translation:

The e-mail send and receive archives of the employees whose job function relates specifically and exclusively to the organizational function that directly corresponds to the subject of a specific subject-specific domain are retrieved.

Human involvement may be required to review the text and ensure that a period is placed at the end of each sentence. Alternately, text based algorithms may be employed that determine the end of a sentence with a high probability of success, and once identified, a period may be automatically placed at the end of sentences.

The text sentences from the e-mail are extracted and used for the creation of the subject-specific domain accuracy improvement file SSDAI file.

(3)—Bulk Text Material Translation:

Bulk text material in magnetic format relating specifically and exclusively to the organizational function directly corresponding to the subject of a specific subject-specific domain are retrieved and in an embodiment all text sentences are extracted there from, and used for, the creation of the subject-specific domain accuracy improvement file (SSDAI file).

Human involvement may be required to review the text and ensure that a period is placed at the end of each sentence. Alternately, text based algorithms may be employed which automatically determine the end of a sentence with a high probability of success. When the algorithm has determined that the end of a sentence has been encountered, a period may be inserted at the end of sentence.

Computer Program to Determine the Initial Threshold Percentage Value for a Subject-Specific Domain

Utilizing a SSDAI file and the specific subject-specific domain for which this file was created, a computer program which may determine the initial threshold percentage value to be used for this specific subject-specific domain, as follows:

During SMT translation run time processing of the subject-specific domain accuracy improvement file (SSDAI File), after SMT has translated a single sentence, the data relating to the highest probability that the translation of a word is correct relating to the each of the individual words in the sentence are mathematically added to a counter that stores a sum of the probabilities that the words with the highest probability of being correct, which will be referred to as the “Total Highest Correctness Probability Correctness Counter” for the SMT translation run. In addition, the number of words in the sentence being processed is mathematically added to a counter that stores the sum of total number of words translated in each sentence, which will be referred to as the “Total Number of Words Counter for the Translation Run.” After the translation processing of the entire file is complete, the “Total Highest Correctness Probability Correctness Counter” is divided by the “Total Number of Words Counter for the Translation Run.” The result of this division is the average highest average percentage value for all words in the subject-specific domain accuracy improvement file which is used as the initial threshold percentage value relating to the specific subject-specific domain. This initial threshold percentage value is employed in the subject-specific domain accuracy improvement process, described below.

Creating a New-High Accuracy Subject-Specific Domain

Each subject-specific domain is created and used uniquely for only one of the three types of translation processing disclosed herein; either voice-to-voice translation, or e-mail translation, or bulk text material translation.

The fact is that in all human spoken languages, the exact same work or expression can have multiple meanings depending upon the context the language is used (e.g., First National Bank, River Bank, You can bank on it, etc.). But when everybody conversing is talking about precisely the same subject, the meaning of words and expressions becomes much more clear and precise.

Therefore, for our purpose, each subject-specific domain created relates to a single specific real-life function as performed by people doing their specific job an organization. As a result, the subject-specific domain may consist of sentences relating specifically to the particular language, terminology & Jargon that workers in a particular business function use while they are performing their specific job, task or mission. Therefore, the sole purpose of subject-specific domains is to reflect the language, terminology and jargon of people performing a specific functional task within an organization—for the purpose of subject-specific translation, such subject-specific language, regardless of formal English grammatical rules, is considered correct.

The source language sentences may be used to create a subject-specific domain for each type of processing disclosed herein. voice-to-voice translation, e-mail translation, and bulk text material translation are derived from the same real-life sources, exactly as detailed above for the creation of the SSDAI File. The source language sentences are then translated by a human translator to the target language in order to create the required parallel corpora for the high-accuracy subject-specific domain.

The second imperative factor in creating a new high-accuracy subject-specific domain is that the investment must be made so that the domain may contain a massive amount of translated Parallel Corpora (e.g., the sentences may include 10-20 million words) to enable near error free translation for utilizing the subject-specific domains which are limited in scope. Given this investment in generating such a vast amount of parallel corpora data, the subject-specific domain may already have an example of most of the jargon that people may say or write while performing their subject-specific task.

Prior to SMT run time, the initial threshold percentage value” for a specific SMT subject-specific domain is computed, as detailed above. Given the above detailed processes, using real-life data for the creation of the subject-specific domain, the computed initial threshold percentage value should be relatively high. The user may specify to the SMT system that the initial threshold percentage value is to be used during SMT processing.

During SMT run time, after SMT has translated a single sentence, the data relating to the highest probability that the translation of a word is correct relating to the each of the words in the sentence (FIG. 3) are compared to the user defined initial threshold percentage value. The sentence is determined to have been translated correctly only in the case that the highest probability that the translation of a word is correct value relating to each and every word in the sentence is either equal to or higher than the user defined initial threshold percentage value. Otherwise, the sentence is determined to have been translated incorrectly.

In an embodiment, all sentences that were translated incorrectly by the SMT system are automatically processed by the appropriate error correction system (See: FIGS. 1 & 2), as detailed below, and subsequent corrections may be input to the SMT training system that the SMT training system is a component of SMT Translation systems, as detailed below. In this manner, the SMT system may thereafter be taught to understand these previously incorrectly translated sentences, and (e.g., by the next day) the same or similar translation error(s) may not happen again. In this manner, the accuracy of translation system may thereby continually increase on an on-going basis.

In order to achieve the highest possible maximum cutting-edge translation accuracy, the initial threshold percentage value relating to the specific subject-specific domain, is continually increased prior to SMT run time, in accordance with the significant error-correction system human translator resources which should be invested.

Improving the Accuracy of an Existing Subject-Specific Domain

Prior to SMT run time, the initial threshold percentage value for a specific SMT subject-specific domain is computed, as detailed above. The user may specify to the SMT system that the initial threshold percentage value is to be used during SMT processing.

During SMT run time, after SMT has translated a single sentence, the data relating to the highest probability that the translation of a word is correct value relating to the each of the words in the sentence (FIG. 3) are compared to the user defined “initial threshold percentage value. The sentence is determined to have been translated correctly only in the case that the highest probability that the translation of a word is correct value relating to each and every word in the sentence is either equal to or higher than the user defined initial threshold percentage value,” Otherwise the sentence is determined to have been translated incorrectly.

In an embodiment, all sentences which were translated incorrectly by the SMT system are automatically processed and corrected within the appropriate error correction system (See: FIGS. 1 & 2), as detailed below, and subsequent corrections may be input to the SMT training system which the SMT Training System is a component of SMT Translation systems, as detailed below. In this manner, the SMT system may thereafter be taught to understand these previously incorrectly translated sentences, and (e.g., by the next day) the same or similar translation error(s) may not happen again. In this manner, the accuracy of translation system may thereby continually increase on an on-going basis.

In order to achieve ongoing translation accuracy improvement, the “initial threshold percentage value relating to the specific existing subject-specific domain, is continually increased prior to SMT run time, in accordance with available error-correction system human translator resources.

SMT Data Extraction for Translation Error File Record Creation

The SMT system may be modified to determine if a translated sentence has either been translated correctly or translated incorrectly, as detailed in the prior section, and the SMT system may include an API (Application Program Interface), via an external module (e.g., via the voice to voice translation system) to cause the SMT system to provide the below detailed information. Alternatively another method extracts the below detailed information via the SMT system for use by any external module, such as the voice to voice translation system:

1—The text of original source language sentence

2—The text of the translated target language sentence

3—For sentences that contain words with multiple meaning(s), a list of the word(s) that the SMT system has determined to be translated incorrectly.

4—An indicator of whether the source language sentence has either been translated incorrectly or translated correctly.

5—The text document Id (or) the voice-to-voice translation conversation Id, or E-Mail ID

6—The source system indicator, which indicates whether the source of the text was bulk text material (or) voice-to-voice (or) E-Mail translation.

Creation of the Translation Error File

A computer program may access and process the information for each sentence extracted from the modified SMT system file, (as well as the “SIF record storage & retrieval key which may be associated with each voice-to-voice type translation Transaction Error File record), as detailed above.

The computer program may include machine instructions that cause a processor to implement the following steps.

A translation error file is created containing a unique file identification key, that uniquely identifies the specific bulk text material document or interactive voice-to-voice translated conversation, or e-mail submitted for the SMT to translate.

A record in the translation error file is generated for each individual sentence translated within the bulk text material document or the interactive voice-to-voice translated conversation or e-mail. The record may include the below detailed data extracted from the SMT system subsequent to the translation by the SMT system, of each individual sentence in the bulk text material or interactive voice-to-voice translated conversation or e-mail translation as follows:

1—The text of original source language sentence

2—The text of translated target language sentence

3—For sentences that contain words with multiple meanings, a list of the words that the SMT system has determined to be translated incorrectly.

4—An indicator whether the source language sentence has either been translated incorrectly or translated correctly.

5—A text document ID (or) voice-to-voice translation conversation ID (or) e-mail ID.

6—A source system indicator indicating whether the sentence is a bulk text material translation or a voice-to-voice translation (or) a e-mail translation.

7—A unique key for storing and retrieving SIF records, which may be used for the subsequent retrieval of the associated sentence information file record. Note that the key is used exclusively for voice-to-voice translation and VR error data, else the key=null (null indicates either a bulk material text-to-text translation or e-mail translation).

The Bulk Text-to-Text Material and E-Mail Translation Error Correction System 100

Referring to FIG. 1, a method for bulk text material and e-mail translation error correction system may include the following steps:

In step 102 of method 100, a record of a translation error is stored in the SMT server (e.g., in a relational database), so that later each record of a translation error in the translation error file that contains a sentence that has been translated incorrectly by the SMT system may be presented to a professional human translator, one record at a time by the bulk text material translation and e-mail translation error correction system.

In step 104, the selected information in the record (which is information relating to records containing sentences that have been “translated incorrectly”) are retrieved by the bulk text material and e-mail translation error correction system (the records may include both the source language sentence that was submitted for translation, as well as the corresponding target language sentence that was determined to have been incorrectly translated by the SMT system).

In step 106, in an embodiment, the sentence that has been translated incorrectly is presented, by bulk text and e-mail error correction system 106 on server 108, to a professional human translator 110, one record (and therefore one sentence) at a time, (which may be highlighted using a technique to bring to the attention of the professional translator to the incorrectly translated sentence(s), as well as the specific word(s) within each incorrectly translated sentence which SMT determined to have been translated incorrectly. For example highlighting incorrectly translated sentences in one color (e.g., yellow), while the specific word(s) within the sentence that have been translated incorrectly may be highlighted in a different color (e.g., red). As a result of the highlighting technique, the professional human translator(s) can easily determine specifically which words the SMT system translated incorrectly and may be able to more effectively translate the sentence for the parallel corpus).

During step 106, the professional human translator 110 may then utilize the information in the record in the bulk text material and e-mail translation error correction system to correctly translate the source language sentence into a correctly translated corresponding target language sentence, thereby, in step 112, creating a correctly translated parallel corpus source and target language sentence. In step 114, the correctly translated parallel corpus source and target language sentences may then be input to the SMT Training System, so that the SMT's training process may ensure that the same translation error may not occur again.

Bulk Material Translation Text Report

In an embodiment, a bulk material translation text report is developed, as detailed below:

A computer program, based on the translation error file creates a bulk material translation text report that displays the entire source language text of the bulk material on a computer screen or a hard copy paper report, with the individual sentences that have been determined by the SMT system to have been translated incorrectly either highlighted, or otherwise marked in any manner whatsoever so that user attention may be drawn to the incorrectly translated individual sentences. The report may be generated for viewing as a hard copy paper, on a computer screen, or by any other means known to those skilled in the art. Furthermore, the report will employ a highlighting technique to bring to the attention of the viewer to both the incorrectly translated sentence(s), as well as the specific word(s) within each incorrectly translated sentence which SMT determined to have been translated incorrectly. For example, highlighting incorrectly translated sentences in one color (e.g., yellow), while the specific word(s) within the sentence that have been translated incorrectly may be highlighted in a different color (e.g., red). As a result of the highlighting technique, the user, at a glance, can perceive both the number of translation errors in a specific text-to-text translation, as well as the specific details of each error.

The Interactive Conversational Data Translation Error Correction System 200

Referring the flowchart in FIG. 2, in step 202 of method 200, the interactive conversational data error correction system may include at least the following steps.

In step 202, each translation error is stored in an individual record in the translation error file for interactive conversations (so that the record may be later selected and presented to a professional human translator, one record—and consequently one sentence—at a time by the interactive conversational data error correction system).

In step 204, selected information in a record of the records from the translation error file (which only relate to records containing sentences that have been “translated incorrectly) is retrieved (e.g., one record at a time). In step 206, a determination is made whether there is a voice recognition error. If there was a voice recognition error, the method proceeds to step 208, and in step 208 an audio recording of the sentence is retrieved. After step 208, the method proceeds to step 210. If there is no voice recognition error, the method 200 proceeds from step 206 directly to step 210. In step 210, the conversation error correction system sends the translation error file record and optionally the audio recording, via server 212 to the professional translator 214. Server 212 and professional translator 214 may be the same as or embodiments of server 112 and professional translator 114, respectively.

In step 210, the sentence that has been translated incorrectly and presented to the professional human translator, one record (e.g., one sentence) at a time may be presented utilizing a highlighting technique to bring to the attention of the professional translator the incorrectly translated sentence(s), as well as the specific word(s) within each incorrectly translated sentence which SMT determined to have been translated incorrectly. For example, highlighting incorrectly translated sentences in one color (e.g., yellow), while the specific word(s) within the sentence that have been translated incorrectly may be highlighted in a different color (e.g., red) As a result of the highlighting technique, the professional human translator(s) may know specifically which words the SMT system determined to have been translated incorrectly, and may be able to more effectively translate a sentence for the parallel corpus. In other embodiment, more than one translation error file record containing more than one sentence may be sent to the professional translator 214, even though the professional translator translates the errors, and stores the corrections, one sentence at a time.

The professional human translator may then correctly translate the source language sentence into a corresponding target language sentence, thereby, in step 216, creating a correctly translated parallel corpus source and target language sentences. In step 218, the correctly translated parallel corpus source and target language sentences may then be input to the SMT Training System, which helps to ensure that the same translation error may not occur again. Sentence parallel corpus file 216 and sentence parallel corpus 112 may be the sentence parallel corpus file, and SMT process 218 and SMT process 114 may be the same process.

Voice Recognition (VR) Error—Sentence Correction Process (208):

The record in sentence information file (SIF) that corresponds to the specific sentence presented to the professional human translator is automatically retrieved based on the unique sentence information file retrieval key stored in the translation error record. In the case that the record indicates that a Voice Recognition (VR) error occurred during the transcription, by the VR module, of the sentence from voice to text, the source sentence presented to the professional human translator is probably be defective, and, the audio recording of the single sentence as spoken by the participant in the conversation is retrieved from the sentence information file (SIF) and made available to the professional human translator. The professional human translator may then listen to the audio recording of the source sentence, and manually transcribe the correct source sentence as spoken by the voice conversation participant. The professional human translator may then proceed to correctly translate the source language sentence into the target language sentences, and generate a correctly translated parallel corpus. The correctly translated parallel corpus source and target language sentences may be input to the SMT Training System, so that the SMT's Training process may ensure that the same translation error may not occur again.

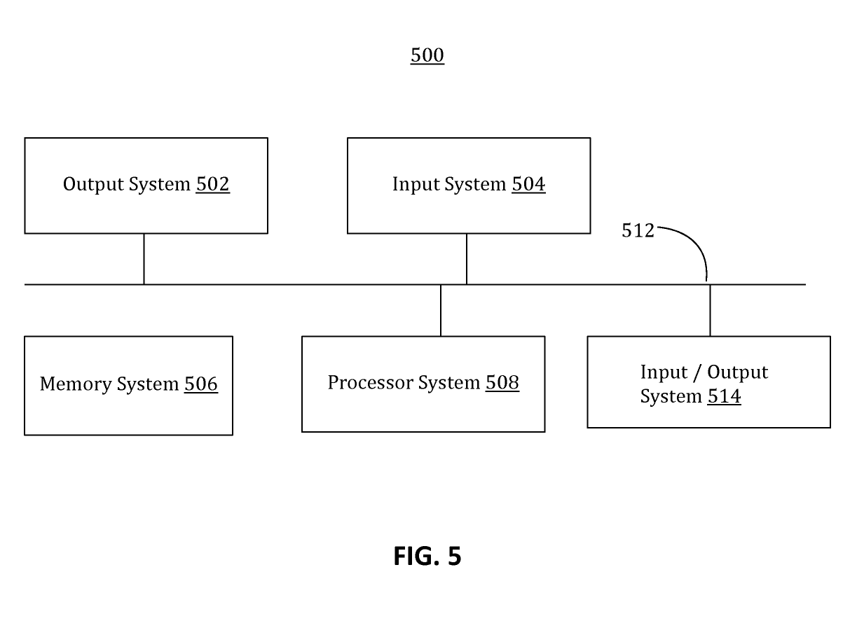

FIG. 5 shows a block diagram of a machine 500, which may be used as a SMT. The machine 500 may include output system 502, input system 504, memory system 506, processor system 508, communications system 512, and input/output device 514. In other embodiments, machine 500 may include additional components and/or may not include all of the components listed above.

Machine 500 is an example of computer that may be used for SMT.

Output system 502 may include any one of, some of, any combination of, or all of a monitor system, a hand held display system, a printer system, a speaker system, a connection or interface system to a sound system, an interface system to peripheral devices and/or a connection and/or interface system to a computer system, intranet, and/or internet, for example. Output system 502 may include a voice synthesizer and/or recording that is played to users to instruct the users to restate a sentence, for example. Output system 502 may include an interface to a phone system or other network system over which voice communications are sent to a user.

Input system 504 may include any one of, some of, any combination of, or all of a keyboard system, a mouse system, a track ball system, a track pad system, buttons on a hand held system, a scanner system, a microphone system, a connection to a sound system, and/or a connection and/or interface system to a computer system, intranet, and/or internet (e.g., IrDA, USB), for example. Input system 504 may include a receiver for receiving electrical signals resulting from a person speaking into a phone or microphone and/or voice recognition software, for example. Input system 504 may include an interface to a phone system or other network system over which voice communications are sent to a user.

Memory system 506 may include, for example, any one of, some of, any combination of, or all of a long term storage system, such as a hard drive; a short term storage system, such as random access memory; a removable storage system, such as a floppy drive or a removable drive; and/or flash memory. Memory system 506 may include one or more machine-readable mediums that may store a variety of different types of information. The term machine-readable medium is used to refer to any medium capable carrying information that is readable by a machine. One example of a machine-readable medium is a computer-readable medium. Memory system 506 may include a relational database for storing translation error file files and voice recognition errors. Memory system 506 may include machine instructions for implementing an SMT system. Memory system 506 may store SIF files. Memory system 506 may include a user interface for a human translator to retrieve voice recognition and/or translation errors and to record the correct translation of a sentence. Memory 506 may store a corpus of pairs of parallel sentences, each pair of sentences being translations of one another. Memory 506 may include several domains for may different language pairs and many subject specific domains. Memory 506 may include instructions for implementing any of the methods and systems disclosed herein.

Processor system 508 may include any one of, some of, any combination of, or all of multiple parallel processors, a single processor, a system of processors having one or more central processors and/or one or more specialized processors dedicated to specific tasks. Also, processor system 508 may include one or more Digital Signal Processors (DSPs) in addition to or in place of one or more Central Processing Units (CPUs) and/or may have one or more digital signal processing programs that run on one or more CPU. Processor 508 may implement any of the machine instructions stored in the memory 506.

Communications system 512 communicatively links output system 502, input system 504, memory system 506, processor system 508, and/or input/output system 514 to each other. Communications system 512 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 514 may include devices that have the dual function as input and output devices. For example, input/output system 514 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 514 is optional, and may be used in addition to or in place of output system 502 and/or input device 504.

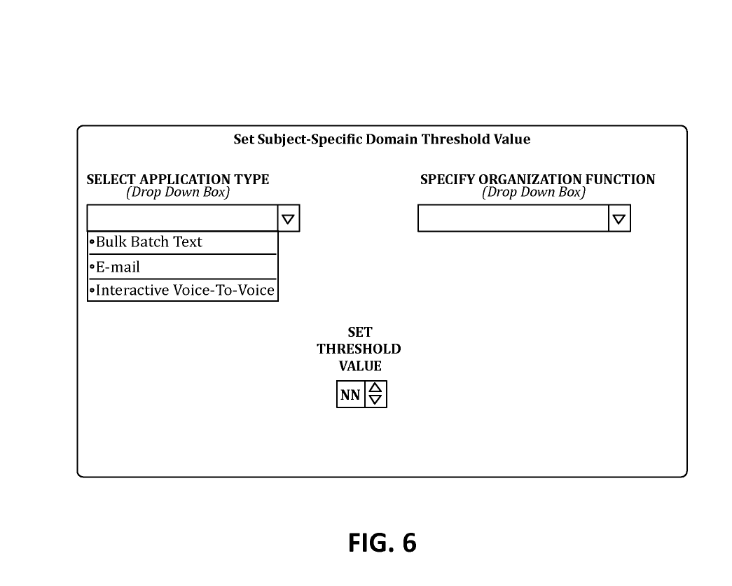

FIG. 6 shows a screen shot of an embodiment of a webpage for setting a threshold value for a subject-specific domain.

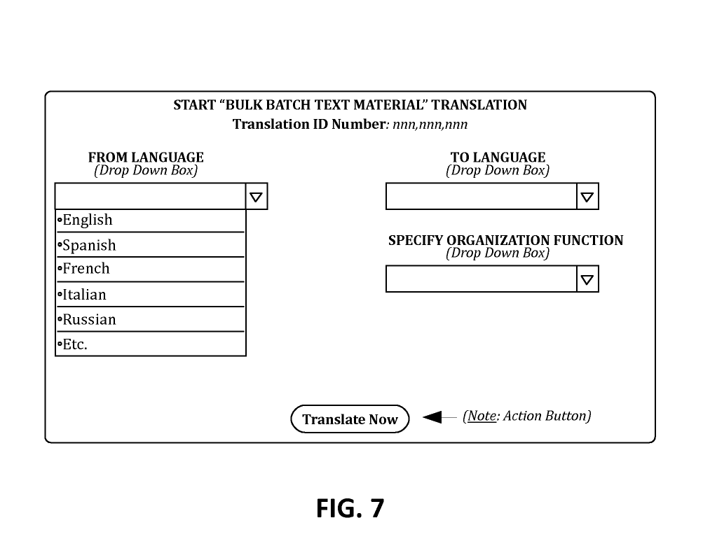

FIG. 7 shows a a screen shot of an embodiment of a webpage for starting a translation of a bulk batch text material.

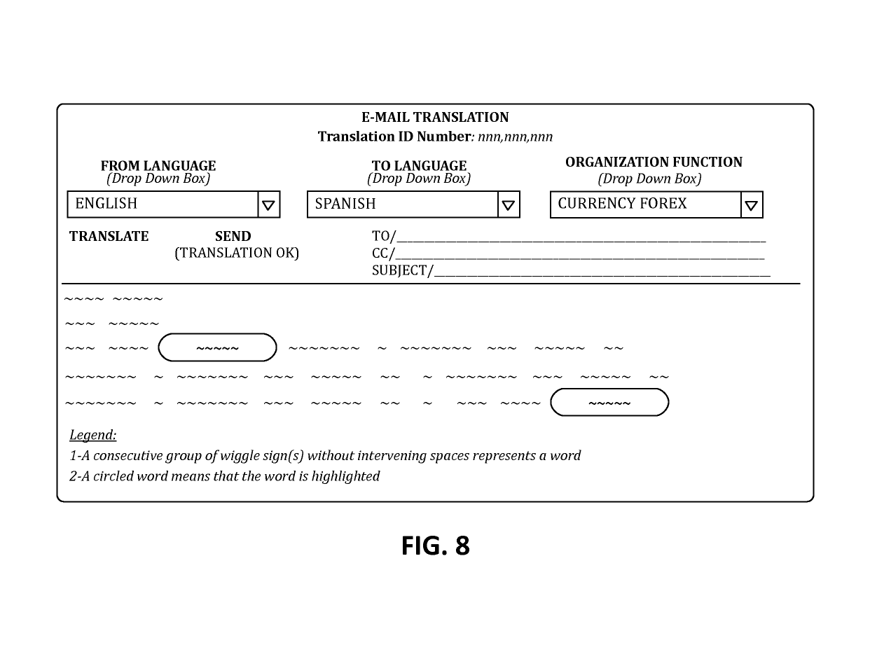

FIG. 8 a screen shot of an embodiment of a webpage for the process of translating an E-Mail.

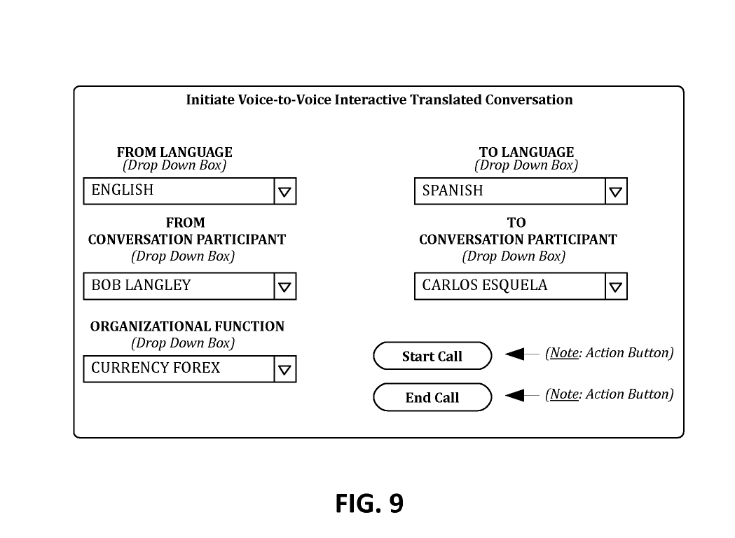

FIG. 9 a screen shot of an embodiment of a webpage for the process of translating of a voice-to-voice interactive conversation.

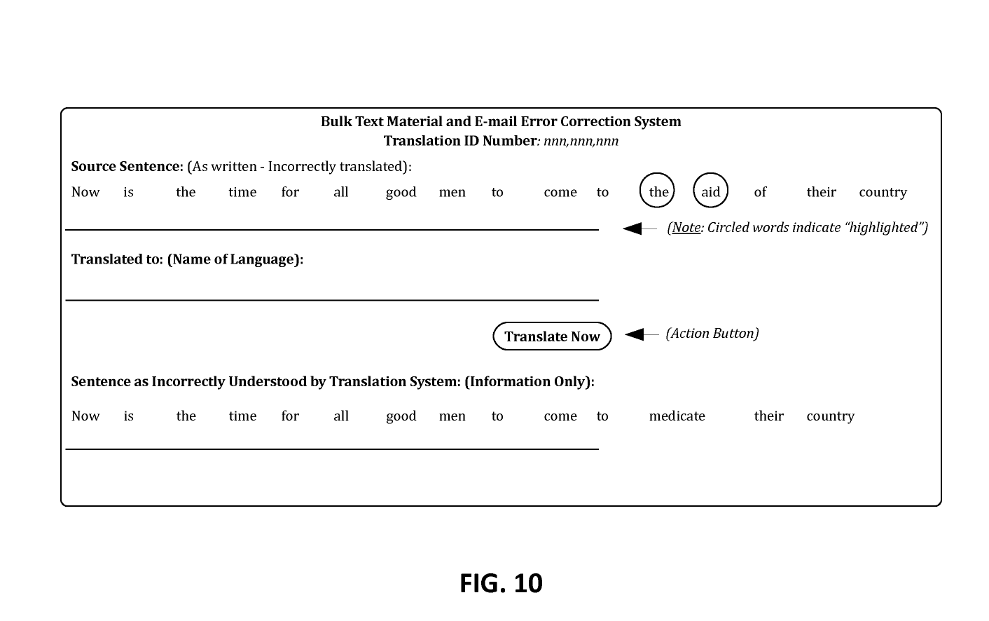

FIG. 10 a screen shot of an embodiment of a webpage for the process of correcting errors in Bulk Text Material and E-Mail.

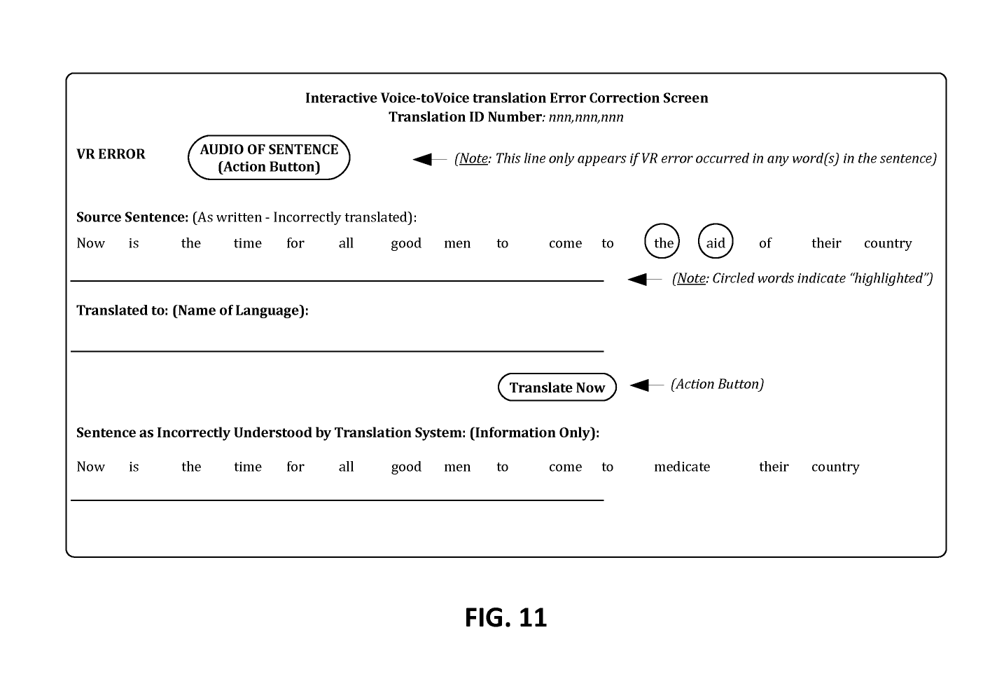

FIG. 11 a screen shot of an embodiment of a webpage for the process of correcting errors in an interactive voice-to-voice translation.

Extensions and Alternatives

In an alternative embodiment, the user may indicate the end of a sentence in another manner other than pressing a button, such as by use of a mouse, trackball, a voice command, or another means. In an alternative embodiment, the requesting of the user to indicate the end of a sentence and/or the requesting of the user to repeat the sentence (e.g., in a simplified manner) may be implemented without employing a human translator.

Each embodiment disclosed herein may be used or otherwise combined with any of the other embodiments disclosed. Any element of any embodiment may be used in any embodiment.

Although the invention has been described with reference to specific embodiments, it may be understood by those skilled in the art that various changes may be made and equivalents may be substituted for elements thereof without departing from the true spirit and scope of the invention. In addition, modifications may be made without departing from the essential teachings of the invention. Those skilled in the art may appreciate that the methods of the present invention as described herein above may be modified once this description is known. Since changes and modifications are intended to be within the scope of the present invention, the above description should be construed as illustrative and not in a limiting sense, the scope of the invention being defined by the following claims.

What is claimed is:

1-10. (canceled)

11. A method for determining whether a sentence has been translated correctly by a Statistical Machine Translation (SMT) system, said sentence translation correctness determination being for sentences that relate to a specific subject and which are designated for translation utilizing a specific SMT subject-specific domain, and for effecting the ongoing incremental improvement of the accuracy of SMT sentence translation of said sentences that relate to a specific subject and which are designated for translation utilizing a specific SMT subject-specific domain, the method comprising:
sending a user interface, from the SMT system to a user system, the user interface having an option that is available to the user for entering a user-defined threshold value; the SMT system including at least one machine having a processor system having at least one processor and having a memory system;
receiving, at the SMT system, input determining the user-defined threshold value;
allowing, by the SMT system, the user to modify the user-defined threshold value prior to and after each translation;
sending a user interface, from the SMT system to a user system, the user interface having an option that is available to the user to specify a subject-specific domain to be utilized for SMT sentence translation; the SMT system including at least one machine having a processor system having at least one processor and having a memory system;
receiving, at the SMT system, input determining the user specified subject-specific domain;
allowing, by the SMT system, the user to modify the user specified subject-specific domain prior to and after each translation;
after the SMT system has produced a translation of a single sentence, determining, by the SMT system, a probability that each possible translation of each word of the sentence is correct;
for each word of the sentence determining, by the SMT system, which possible translation has a probability that the translation is correct that is a highest value compared to other possible translations of the word; and
after the SMT has translated the single sentence, for each word of the sentence,
comparing, by the processor system, the highest value to the user-defined threshold value to determine whether the highest value is either equal to, or higher than, the threshold value, and
if the highest value relating to each word in the sentence is either equal to or higher than the user defined threshold value, presenting a translation of the sentence as a correct translation, otherwise the sentence is determined to have been translated incorrectly;
effecting the ongoing incremental improvement of the accuracy of SMT sentence translation of sentences that relate to a specific subject and which are designated for translation utilizing a specific SMT subject-specific domain by way of
(1)—the user entering a user-defined threshold value for SMT translation by a specific subject-specific domain
(2)—submitting to SMT individual sentences, the subject of said sentences relating directly to the subject of the specific subject-specific domain, for translation, one sentence at a time
(3)—if SMT determined that the sentence submitted for translation was translated incorrectly, sending the incorrectly translated sentence to a human translator for translation
(4)—receiving from the human translator a translation of the sentence that was incorrectly translated, therein creating a correctly translated parallel corpus source and target language sentences
(5)—inputting the correctly translated parallel corpus source and target language sentences into a training system for the SMT subject-specific domain, so that the same translation error will not occur again
the continuing and repeated incremental increase of the user-defined threshold value by the user for SMT translation by the subject-specific domain at times that the user determines that there is a sustained and measurable decrease in the percentage of incorrectly translated sentences, and the subsequent repetition of steps #s 2 through 5 above until the desired level translation accuracy relating to sentences translated utilizing the subject-specific domain has been achieved.

12. The method according to claim 11, further comprising:
receiving a specification of the language to be spoken by each participant in a voice-to-voice conversation;
receiving a specification of the specific subject of the voice-to-voice conversation;
receiving audio information generated by a speaker vocalizing a sentence in a source language;
transforming the audio information into text information, the translation being a translation of the text information of a source sentence, and
if the translation of the text information of the source sentence is determined to have been translated correctly, then
(1)—vocalizing, by a voice synthesis module, the translation;
(2)—allowing the speaker to continue verbalizing his/her next sentence without interruption;
if the translation is determined to be incorrect, then
(1)—interrupting the speaker, by a voice synthesis message spoken in a language of the speaker, informing the speaker that the sentence was not understood by the SMT System;
(2)—playing to the speaker an audio recording of the speaker verbalizing the sentence spoken;
(3)—requesting, by the voice synthesis message in the language of the speaker, the speaker to restate the sentence using different words;
(4) receiving from the speaker a restatement of the sentence; and
(5)—repeating steps 1 through 4 until the sentence spoken by the speaker has been translated correctly.

13. The method according to claim 11 further comprising:
receiving a specification of a language of an e-mail and a specification of a language to which the e-mail is to be translated;
receiving a specification of the specific subject of the e-mail;
receiving text of the e-mail;
receiving a request from a user machine to translate the e-mail;
in response translating the e-mail;
if the SMT system detects at least one sentence that has been determined to have been translated incorrectly, sending information for rendering a display of the e-mail to the user's machine, with the at least one sentence that has been translated incorrectly highlighted;
receiving a rewrite of the at least one sentence in different words and a request for a translation of the at least one sentence; if at least one sentence was translated incorrectly, repeating the sending of the display of the e-mail to the user's machine, the receiving of the rewrite of the at least one sentence in different words, and the request for the translation of the at least one sentence, until all sentences in the e-mail have been translated correctly; and
preventing the e-mail from being sent until every sentence in the e-mail has been determined to have been translated correctly.

14. The method according to claim 11 further comprising:
receiving a specification of a file to be translated;
receiving a specification of the specific subject of the file to be translated;
receiving a request specifying a language in which the selected file is written and the language to which the file is to be translated;
initiating a file translation process;
performing a translation error correction for the file.

15. The method according to claim 11, further comprising performing a sentence error correction and subject-specific domain accuracy improvement process including at least:
sending a sentence that was incorrectly translated to a human translator for translation, the sentence being from a specific bulk text material file or a specific e-mail that was submitted for translation, with one or more words that were translated incorrectly within the sentence highlighted;
receiving from the human translator a translation of the sentence that was incorrectly translated, therein creating a correctly translated parallel corpus source and target language sentences;
inputting the correctly translated parallel corpus source and target language sentences into a training system for the SMT, so that the same translation error will not occur again.

16. The method according to claim 11, further comprising performing a sentence error correction and subject-specific domain accuracy improvement process including at least:
sending a sentence that was incorrectly translated to a human translator for translation, the sentence being from a specific voice-to-voice interactive conversation that was submitted for translation, with one or more words that were translated incorrectly within the sentence highlighted;
receiving from the human translator a translation of the sentence that was incorrectly translated, therein creating a correctly translated parallel corpus source and target language sentences;
inputting the correctly translated parallel corpus source and target language sentences into a training system for the SMT, so that the same translation error will not occur again.

17. A method according to claim 11 further comprising:
sending a sentence to a human translator for translation, the sentence being from a subject-specific voice-to-voice interactive conversation, the sentence having been identified as being associated with a voice recognition error that occurred, thereby resulting in an inability of the voice recognition module to correctly transcribe a source sentence from voice to text;
playing an audio recording of a single sentence as spoken by a conversation participant during the voice-to-voice interactive conversation so as to enable the human translator to listen to the audio recording of the sentence and manually transcribe the source language sentence to text;
receiving from the human translator a translation of the sentence that was incorrectly translated, therein creating a correctly translated parallel corpus source and target language sentences;
inputting the correctly translated parallel corpus source and target language sentences into a training system for the SMT, so that the same translation error will not occur again.

18. The method according to claim 11, further comprising:
if it is determined that a sentence has been translated incorrectly, storing the sentence that was incorrectly translated in a location where a human translator has access, presenting an interface for the human translator with tools for accessing incorrectly translated sentences one at a time;
receiving, by the interface, a request to correctly translate an incorrectly translated sentence;
sending information for rendering the incorrectly translated sentence, the information including information for displaying the incorrectly translated sentence that was requested, highlighting one or more words that were translated incorrectly within the incorrectly translated sentence;
in response, receiving from the human translator a translation of the sentence that was incorrectly translated, therein creating a correctly translated parallel corpus source and target language sentences;
inputting the correctly translated parallel corpus source and target language sentences into a training system for the SMT, so that the same translation error will not occur again.

19. A method according to claim 15, further comprising computing an approximation of the average of the highest threshold values for each word with one or multiple meanings within each sentence used to generate a given subject-specific domain, the computing including at least:
deriving a statistically large quantity of sentence data relative to a size of the given subject-specific domain with sentence data relevant to the subject of the subject specific domain; the statically large quantity being large enough to be statistically significant and therein representative of a true state of the subject specific domain;
accumulating the statistically large quantity of sentence data relating to the subject of the given subject-specific domain, and each sentence thereof is stored as a record in a file, said file being referred to herein as a “Subject-Specific Domain Accuracy Improvement File” (SSDAI file), removing from a specific SSDAI file sentences having Voice Recognition (VR) errors;
inputting to the SMT system the SSDAI file; determining a average of the highest threshold values for each word with one or multiple meanings within each sentence in the SSDAI file;
1—after the SMT system has translated a sentence contained in a SSDAI file record, a highest probability that a translation of a word is correct relating to each of individual word in the sentence are mathematically added to a first counter;
2—the number of words in the SSDAI file sentence being processed is mathematically added to a second counter;
3—after the translation processing of all sentences in the SSDAI file is complete, the first counter is divided by the second counter, resulting in an average highest percentage value for all words in the SSDAI, which, given a statistically large SSDAI file relative to a given subject-specific domain, is an approximation of the average of the highest threshold values for each word with one or multiple meanings within each sentence in the specific subject-specific domain.

20. A method according to claim 19, further comprising improving an accuracy of a subject-specific domain on an on-going progressive basis, wherein,
preparing for application run-time a specific SSDAI file relating specifically to the subject of a given subject-specific domain by utilizing a Bulk Text Material Translation System which utilizes a Statistical Machine Translation (SMT);
using the above mentioned specific SSDAI file as input, computing an approximation of an average of highest threshold values for each word with one or multiple meanings within each sentence used to generate a given Statistical Machine Translation (SMT) subject-specific domain and setting the user-defined threshold value to the approximation of the average of the highest threshold values for the above mentioned Batch Text Material Translation application run;
processing sentences that have been translated incorrectly during the above mentioned Batch Text Material application run by a sentence error correction and subject-specific domain accuracy improvement process;
continually raising the user defined threshold value in user defined intervals and repeating the above Batch Text Material Translation application run so as to identify further incorrectly translated sentences to be processed by the sentence error correction and subject-specific domain accuracy improvement process;
repeating the preparing, the using, the processing and the continually raising until the desired highest threshold value for the specific subject-specific domain has been achieved based on computing the approximation of the average of the highest threshold values for each word with one or multiple meanings within each sentence used to generate a specific Statistical Machine Translation (SMT) subject-specific domain.
